(19) United States
(12) Patent Application Publication
(10) Pub. No.: US 2014/0258024 A1
(43) Pub. Date: Sep. 11, 2014

(54) SYSTEMS AND METHODS OF IDENTIFYING A GROUP OF ITEMS FOR ATTAINING A TARGETED SALES AMOUNT

(71) Applicant: Jeremiah Joseph Akin, Pleasant Hill, CA (US)

(72) Inventor: Jeremiah Joseph Akin, Pleasant Hill, CA (US)

(73) Assignee: eBay Inc., San Jose, CA (US)

(21) Appl. No.: 13/793,699

(22) Filed: Mar. 11, 2013

(51) Int. Cl. G06Q 30/06

(52) U.S. Cl. CPC G06Q 30/0631
USPC 705/26.7

(57) ABSTRACT

A system receives a revenue target from a user, and receives a plurality of images. Each image contains an item. The system identifies a plurality of items from the plurality of images. The system searches a database to determine a selling price estimate for each item of the plurality of items, and generates a proposed combination of items to sell based, at least in part, on price estimates for the proposed combination of items adding up to at least the revenue target.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2013 by eBay, Inc. All Rights Reserved.

### TECHNICAL FIELD

This patent document pertains generally to network communications, and more particularly, but not by way of limitation, to systems and methods of identifying a group of items for attaining a targeted sales amount.

### BACKGROUND

At one or more times in a person's life, that person may have a need or desire for a particular amount of money, which in some circumstances is referred to as spending money or disposable income. At that same time, the person may have several items in his or her house (and particularly, in his or her basement, attic, and/or garage) that he or she no longer wants or needs. Such items could be sold in an attempt to acquire the needed or desired amount of money. However, it is difficult, if not impossible, at least prior to the sale of such items or the attempted sale of such items, for a person to determine if the sales value of the unwanted or unneeded goods is equal to or greater than the needed or desired amount of money. Additionally, if there are items that the person could part with but would rather not, it is difficult for the person to determine if he or she could acquire the needed or desired amount of money without selling the items that he or she would rather keep.

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### BRIEF DESCRIPTION OF DRAWINGS

Some embodiments are illustrated by way of example and not limitation in the figures of the accompanying drawings in which:

FIG. 1 is a block diagram illustrating an architecture within which systems and methods for marketplace listings using a camera enabled mobile device may be implemented, in accordance with an example embodiment;

FIG. 2 is a block diagram showing a multiple listing engine, in accordance with an example embodiment;

FIG. 3 is a block diagram showing back and front views of a camera enabled mobile device, in accordance with an example embodiment;

FIGS. 4A and 4B are a flowchart illustrating an example system and method for identifying a group of items which can be published for sale in order to attain a revenue target or a targeted sales amount, as may be used in an example embodiment;

FIG. 5 is a flowchart illustrating another example system and method for identifying a group of items which can be published for sale in order to attain a revenue target or a targeted sales amount, as may be used in an example embodiment;

FIG. 6 is a flowchart illustrating an additional example system and method for identifying a group of items which can be published for sale in order to attain a revenue target or a targeted sales amount, as may be used in an example embodiment;

FIG. 7 is a flowchart illustrating yet another example system and method for identifying a group of items which can be published for sale in order to attain a revenue target or a targeted sales amount, as may be used in an example embodiment; and

FIG. 8 is a diagrammatic representation illustrating an example machine in the form of a computer system within which a set of instructions for causing the machine to perform any one or more of the methodologies discussed herein may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Online marketplaces allow sellers (e.g., people and business entities) to publish listings describing items being offered for sale to potential buyers. The online marketplace may support one or more offering types, including, for example, fixed price sales, auctions, and hybrids thereof. The online marketplace may provide transaction services to the sellers such as payment services, shipping services, conflict resolution services, and the like.

When a person would like to sell one or more items (usually personally owned items) to generate some needed cash, the person conducts some sort of inventory to determine what could be sold to generate such cash. However, more likely than not, the person is not sure what sales strategy would work best. Should the person put all items up for sale until the desired amount is obtained? Should the person put up the items in perceived increasing or decreasing value until the needed cash is obtained? Should the person start with the items to which he or she is least attached until the needed cash is raised? Should the person just sell everything and see what amount of case can be raised?

In an embodiment, a person can either take a picture of the items that he or she would like to sell, or simply retrieve or make a list of the items that he or she would like to sell. When the person chooses to use the picture-based embodiment, the person can use a camera-enabled mobile communications device or other suitable means to generate digital images of the items. The person sends the picture or list of the items to a third party, such as a network-based publication system. The network-based publication system receives the list, and if the transmission includes one or more pictures, identifies one or more of the plurality of items in the pictures or images. If the network-based publication system needs assistance in identifying the items in the images, or needs additional information relating to the items in the images or list, the network-based publication system can request such information from the person. The network-based publication system can then search a database to determine a price estimate for each of the one or more items, and generate a list of the one or more items and a price estimate for each of the one or more items. The network-based publication system can then publish for sale the items on the list.

In another embodiment, the person can inform the network-based publication system of the amount of money needed or desired by the person (i.e., how much money the person would like to make from the sale of the items). The network-based system can then determine, for example by searching a sales history database, one or more combinations of items from the list whose sum of estimated prices is equal to or greater than the amount of money needed or desired by the person. The network-based publication system can then publish for sale the one or more combinations of items.

Consequently, for some example embodiments, systems and methods for creating marketplace listings of a combination of items that will likely lead to a targeted revenue or desired sales amount are disclosed. In some of these embodiments, a camera enabled mobile device is used. One example embodiment may comprise receiving a targeted revenue, a request via a camera enabled mobile device to list one or more sale items, a receipt of images having the one or more sale items (the images being taken by the camera enabled mobile device), a receipt of data associated with the one or more sale items, and based on the data, a listing of the one or more sale items on a network-based publication system or a network-based marketplace.

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

A camera enabled mobile device may include a mobile Operating System (OS) run on a hardware platform adapted for the OS. A camera enabled mobile device may include a Graphical User Interface (GUI), which may be based on the concept of direct manipulation of a touch screen monitor with gestures. The GUI may permit a nearly instantaneous response to user input. The gestures for interaction with the mobile OS may include swiping, tapping, pinching, and/or reverse pinching.

For some example embodiments, systems and methods for marketplace listings and for attaining targeted revenue using a camera enabled mobile device may permit a user to take one or more pictures illustrating items to be listed on a marketplace and provide data related to the pictures. The data may be utilized to tag the items to be listed. The items may be extracted from the pictures, tagged with the data and listed at the same time. Data on the items can also be retrieved from a sales history database of a network-based publication system. A software application running on the camera enabled mobile device may utilize rich media technology to enable a user to take multiple pictures of various items or a single picture of a group of multiple items, tag the items with data, and list the items for sale on a marketplace. In some example embodiments, a draft area may be utilized as an intermediary stage for images and data to be collected over a period of time before the data is associated with the items in the images and listed on a marketplace. Data on the items can also be retrieved by the network-based publication system using image recognition technology and the sales history database.

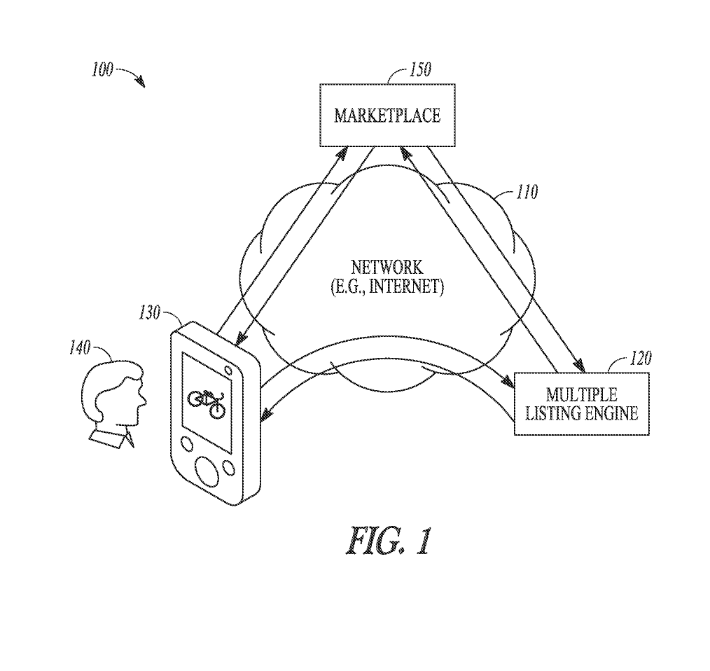

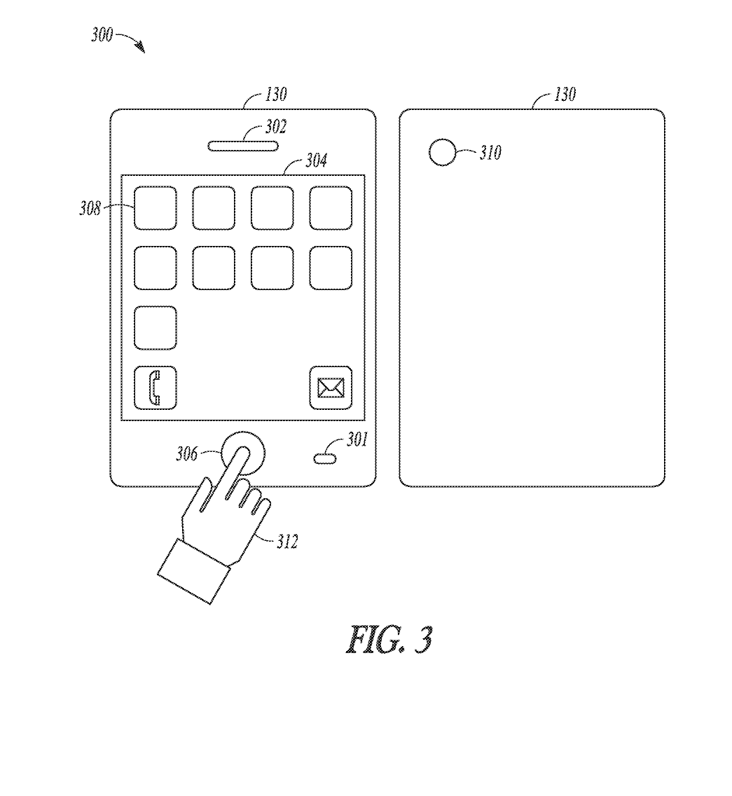

FIG. 1 illustrates a network environment 100 that may include a network 110, a multiple listing engine 120, a camera enabled mobile device 130, a user 140, and an electronic marketplace 150. The network 110 may comprise a plurality of data processing nodes interconnected for the purpose of data communication. The camera enabled mobile device 130 may comprise a camera coupled to a mobile device. The camera enabled mobile device 130, in some example embodiments, may include a Graphical User Interface (GUI) which may be manipulated by gestures of a user 140's hand. In a typical GUI, instead of offering only text menus or requiring typed commands, the system presents graphical icons, visual indicators or special graphical elements called widgets that may be utilized to allow the user to interact with client applications. The camera enabled mobile device 130 may be configured to utilize icons in conjunction with text, labels or text navigation to fully represent the information and actions available to users. Example GUI and client applications are described in more detail with reference to FIG. 3.

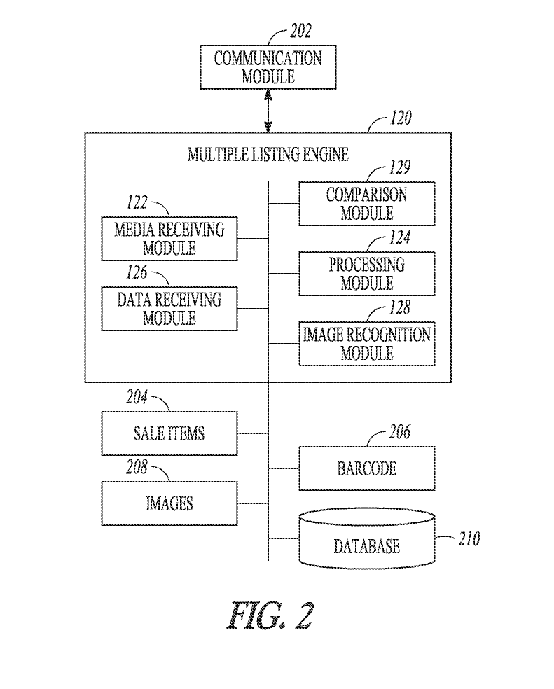

The user 140 is a person interacting with the camera enabled mobile device 130 via the GUI. In some other embodiments, the user 140 may be represented by an automated process designed to simulate a person operating the camera enabled device 130. The electronic marketplace 150, in the context of the example network environment 100, may be a network-based publication system, and more particularly, may be an online auction and fixed price shopping website configured to permit individual users and businesses to buy and sell goods and services (e.g., eBay). The electronic marketplace 150 may be a part of the worldwide electronic commerce which includes buying and selling of products or services over electronic systems such as the Internet and other computer networks. The multiple listing engine 120, in some example embodiments, may include various components facilitating listing of items for sale. A network-based publication system or other network-based system for marketplace listings using a camera enabled mobile device 200 is described by way of example with reference to FIG. 2.

FIG. 2 is a block diagram showing the system for marketplace listings using a camera enabled mobile device in accordance with an example embodiment. The system for marketplace listings using a camera enabled mobile device in some example embodiments may include a communication module 202 coupled to a multiple listing engine 120. The system for marketplace listings using a camera enabled mobile device may further include data relating to sale items 204, bar codes 206, images 208, and a database 210.

The communication module 202, in some example embodiments, may be configured to receive a request from the camera enabled mobile device 130 to list one or more the sale items 204 selected by a user from the images 208. For some example embodiments, user interaction may not be needed because the sale items 204 are selected based on predetermined default criteria, or selected so that estimated prices of the items sum up to targeted revenue. The communication module 202 may be coupled to the multiple listing engine 120, which in turn includes a media receiving module 122, a processing module 124, a data receiving module 126, and an image recognition module 128.

The media receiving module 122, in some example embodiments, may be configured to receive the images 208. The images 208 may be taken by the user 140 operating the camera enabled mobile device 130. The images 208 may include the sale items 204. For example, the user 140 may be willing to sell multiple items located in his garage. The user 140 may utilize the camera enabled mobile device 130 to take the images 208 in his garage so that each image includes a plurality of the sale items 204, or so that each image 208 includes one item for sale. The data receiving module 126 may be configured to receive data associated with the sale items 204. The data may be provided by the user 140 or created automatically based on the images 208, such as by accessing a sales history database which could be part of the database 210.

The processing module 124, in some example embodiments, may be configured to list the sale items 204 for sale, according to the targeted revenue received from the user 140. The sale items 204 are extracted from the images 208 received by the media receiving module 122 and the data received by the data receiving module 126. As noted, the data receiving module can receive data relating to the sale items 204 directly from the user or from a sales history database in the database 210. The processing module 124, in some example embodiments, may be configured to provide default data when no data is provided by the user. For example, if the user 140 provides no data and the sale items 204 are of low value, the processing module 124 may associate the sale items 204 with default data. For some example embodiments, the sale items 204 may be classified automatically with the help of image recognition technology via the image recognition module 128. Additionally, a light weight listing process may be utilized in which the user 140 may be provided with a few options. This approach may provide the multiple listing engine 120 with the data sufficient to list the sale item 204.

The processing module 124 may need data to tag the sale items 204. The data may be supplied by a user or derived using some predetermined methods. The user may be explicitly asked to provide the data. Thus, the processing module 124 may provide the user 140 with predetermined selection options. For example, a message may be displayed asking the user whether an item shown in the image is a certain product. Other questions may be asked.

It may be determined by the processing module 124 whether or not the user 140 selects an offered option. If the user 140 selects an option, the processing module 124 may receive the data provided by the user 140. The data may be provided via the GUI of the camera enabled mobile device 130 using various supported gestures. The GUI of the camera enabled mobile device 130 may support direct manipulations including one or more of the following gestures: multi-touching, swiping, tapping, pinching, and reverse pinching. If, on the other hand, it is determined that the user 140 did not select any options, the processing module 124 may receive an automatically-generated minimal description of the sale items 204. The processing module 124 may generate default data based on the minimal description received.

In some embodiments, the processing module 124 may allow more than one seller to add items to a collection. For example, a first seller may have a collection of items that the first seller wishes to sell. The first seller may be acquainted with one or more additional sellers who have items to sell that complement the collection of the first seller. The first seller may allow the additional sellers to electronically add their items to the collection for sale.

When the sale has ended, a comparison module 129 is configured to, based on buyer activity, determine whether the group of items is sold, whether the group of items is not sold, or whether only a portion of the group of items is sold. The comparison is made automatically, without human intervention. The comparison module 129 may operate according to one or more sets of conditions set by the seller. In one embodiment, the comparison module 129 compares a sum of auction bids or fixed price bids for the respective items to the revenue target. This comparison can be done for the proposed combination as a whole or when only a portion of the proposed combination has been sold. The user or seller is notified when the revenue target is met, and provided information on what items sold at what prices. The seller can also be given periodic updates on the status prior to reaching the revenue target.

The database 210, in some example embodiments, may be configured as a structured collection of records or data that is stored in a computer system which a computer program or a person using a query language may consult to answer queries. The records retrieved in answer to queries are information that can be used to make decisions. The database 210 may store the images 208 as well as data relating to the sale items 204. The sale items 204 may include goods and/or services which are shown in the images 208 provided by the camera enabled mobile device 130 and listed on the marketplace 150 by the multiple listing engine 120.

For some example embodiments, bar codes 206 may be utilized to provide the data needed for the sale items 204 to be listed on the marketplace 150. The bar code 206 may be, for example, a Universal Product Code (UPC), which is widely used for tracking sale items 204. Thus an image of the bar code 206 may be utilized to generate tags describing the sale items 204. The images 208, in some example embodiments, are photographs of the sale items 204. Each image of the images 208 may include more than one item.

FIG. 3 is a block diagram 300 showing back and front views of a camera enabled mobile device 130, in accordance with an example embodiment. The camera enabled mobile device 130, in some example embodiments, includes a receiver 301, a speaker 302, and a touch screen 304. The touch screen 304 may display a GUI, which in turn includes application icons 308. The camera enabled mobile device 130 may further include a home button 306 and a camera 310, which is shown on the back view of the camera enabled mobile device 130 but may, as well, be located in the front. Also shown is a hand 312 of the user 140 which may operate the camera enabled mobile device 130 by manipulating the camera enabled mobile device 130 through gestures of the hand 312.

For some example embodiments, because the camera enabled mobile device 130 has native camera integration, the user 140 may utilize the camera enabled mobile device 130 for various applications adapted to take advantage of this functionality. For example, a user 140 may take a picture of the bar code 206 associated with a sale item. This may be useful in a situation wherein the user 140 has previously purchased an item, has never used or removed the item from its original packaging, and now wants to sell this item and perhaps other items to reach a targeted revenue or desired sales amount. An application adapted to read the bar code 206 may determine generated data descriptive of the sale item based on the picture of the bar code 206. The data may be utilized in a listing of the item by the multiple listing engine 120 or in a search for similar items on the marketplace 150. The search results may be analyzed and displayed (e.g., average price of the product). The search result may be utilized in tagging the sale items 204.

In some example embodiments, the camera enabled mobile device 130 may permit listing of the sale items 204 based on an image of the item and a minimal description. In some example embodiments, in order for the user 140 to receive data, the user may be offered a selection of choices. In further example embodiments, before the sale items 204 are listed on the marketplace 150, the images 208 and related data are compiled in a personal draft area. Thus, the user 140 may take a picture, add some tags to the picture, and then place the picture and the tags in the personal draft area.

The receiver 301 may be a device for converting sound into electric signals and vice versa. The touch screen 304, in some example embodiments, is a display which may detect the presence and location of a touch within the display area. The touch screen 304 may be operated by touch or contact to the display of the device by a finger or hand. In some example embodiments, the touch screen 304 may sense other objects, such as a stylus. The home button 306, in some example embodiments, may be a button that permits a user to see the icons 308. The icons 308 may be utilized to start software applications installed on the camera enabled mobile device 130.

A web application running on the camera enabled mobile device 130 is an example of a software application that may be started with one of the icons 308. A web application running on the camera enabled mobile device 130 may employ generic web technologies that do not take advantage of the native capabilities of the camera enabled mobile device 130. The web application may also mix HyperText Markup Language (HTML) content with native content. Further example applications running on the camera enabled mobile device 130 may be designed for instant notifications or real time alerts of users of the camera enabled mobile device 130. Camera 310 is a device used to capture images, either as still photographs or as sequences of moving images (movies or videos).

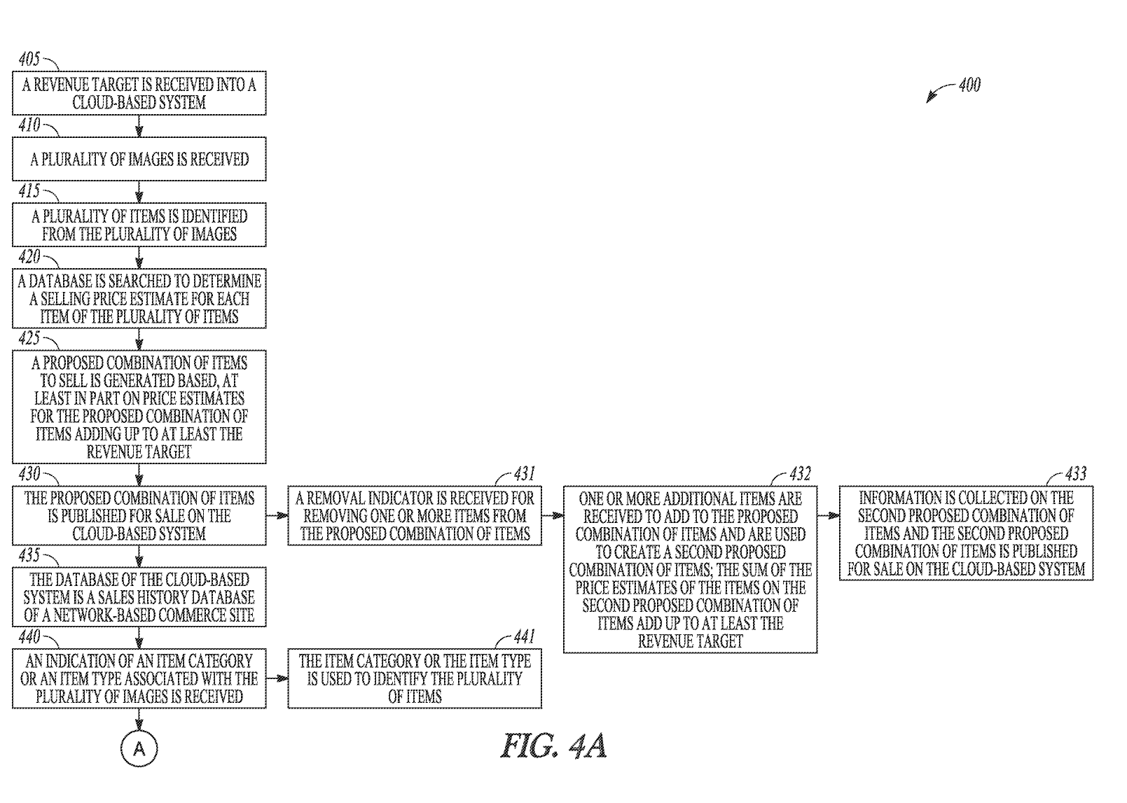

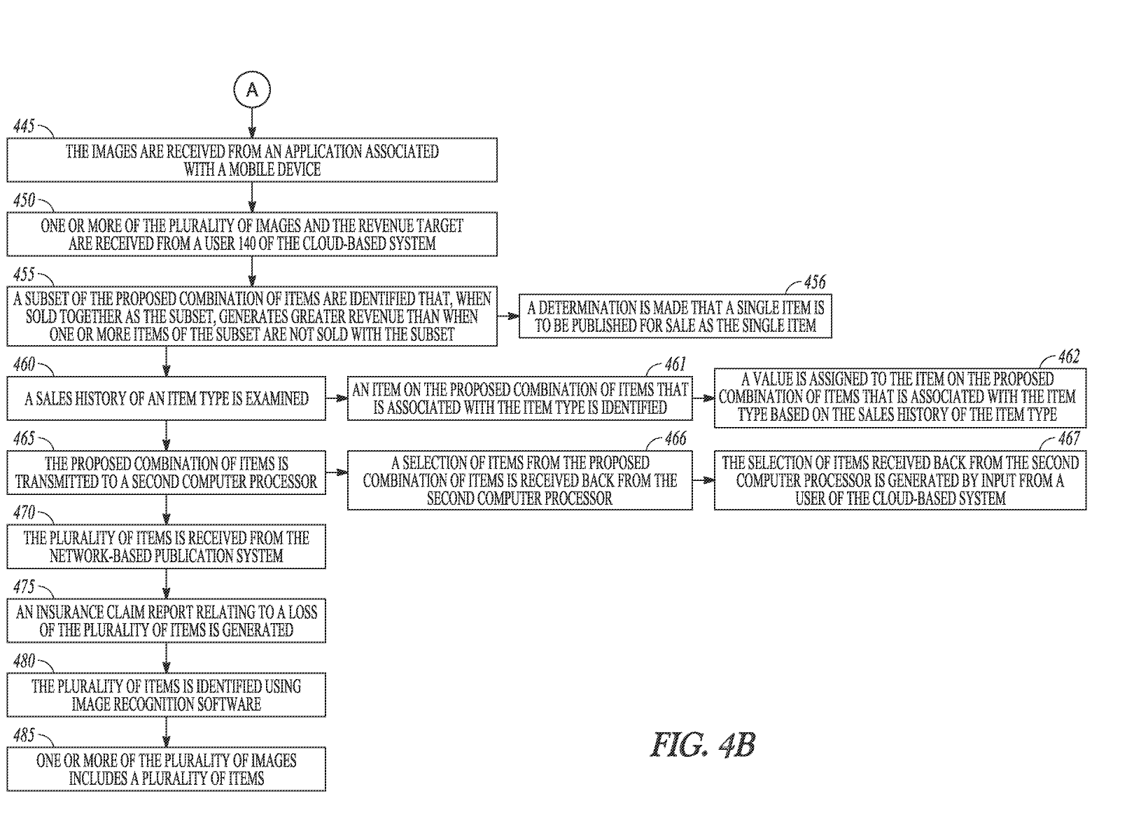

FIGS. 4A, 4B, 5, 6, and 7 are flowchart-like diagrams of features and operations of example embodiments of systems and processes 400, 500, 600, and 700 for determining a collection of items to sell to meet a targeted revenue or desired sales amount. FIGS. 4A, 4B, 5, 6, and 7 include a number of process blocks 405-485, 505-525, 605-645, and 705-730. Though arranged serially in the examples of FIGS. 4A, 4B, 5, 6, and 7, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

In one or more embodiments of the methods 400, 500, 600, and 700, the camera enabled mobile device 130 is used. The methods 400, 500, 600, and 700 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the multiple listing engine 120, illustrated in FIG. 2. The methods 400, 500, 600, and 700 may be performed by the various example modules discussed above with reference to FIG. 2. Each of these modules may comprise processing logic.

The system and method of FIGS. 4A and 4B, in an embodiment, can be implemented in a cloud-based system. The cloud based system can include a server communicatively coupled to a network and can further include a processor and a memory device. The memory device can include instructions that when executed on the server, implement/execute the system/process of FIGS. 4A and 4B.

Specifically, at 405, a revenue target is received into the cloud-based system 100. The revenue target can be received from the user 140, who can send it to the cloud-based system 100 or marketplace 150 via his or her camera enabled mobile device 130. At 410, the system 100 can also receive a plurality of images. Each of the plurality of images can include one or more items that the user would like to publish for sale on the marketplace 150 in the cloud-based system 100. At 415, the cloud-based system 100, and in particular the image recognition module 128, identifies a plurality of items from the plurality of images. At 420, the multiple listing engine 120 searches the database 210 to determine a selling price estimate for each item of the plurality of items. At 425, the processing module 124 generates a proposed combination of items to sell from the plurality of items. The proposed combination of items is based, at least in part, on price estimates for the proposed combination of items adding up to at least the revenue target.

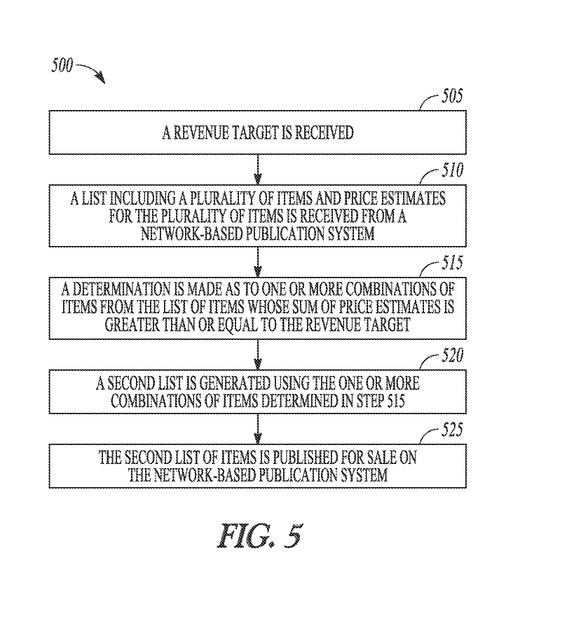

In another embodiment, as illustrated in FIG. 5, a computer readable storage device includes instructions that when executed by a processor execute a process to identify a combination of items to publish for sale on the marketplace 150 to attain a revenue target. Specifically, at 505, a revenue target is received. The revenue target can be received from a user 140 of a network-based publication system 100, such as an online marketplace 150 or an online auction site. At 510, a list including a plurality of items and price estimates for the plurality of items is received from the network-based publication system 100. For example, if the user 140 has previously listed the plurality of items for sale on the network-based publication system 100, the list can be received from the items database 204 in such a network-based publication system 100. At 515, a determination is made as to one or more combinations of items from the list of items whose sum of price estimates is greater than or equal to the revenue target. At 520, a second list is generated using the one or more combinations of items determined in step 515. At 525, the second list of items is published for sale on the network-based publication system 100. Consequently, in the embodiment of FIG. 5, a first list of items serves as a base from which to generate a proposed list of items to be published for sale for attaining a revenue target. As will be explained in detail below, a user 140 can remove and/or add items from the proposed list of items depending on the wants, needs, and desires of the user.

The embodiment of FIG. 5 differs from the embodiment of FIGS. 4A and 4B in that the embodiment of FIGS. 4A and 4B identifies items for potential listing for sale via image recognition. The embodiment of FIG. 5 does not involve image recognition, but rather uses a list of items and prices, and in an embodiment, a list of items and prices from a network-based publication system 100. An advantage of the embodiment of FIGS. 4A and 4B is that it is more automated than the embodiment of FIG. 5, since the image recognition takes care of identifying the items in an image, and any such items need not be listed on a network-based publication system 100. An advantage of FIG. 5 is that there is little or no concern about anomalies associated with image recognition.

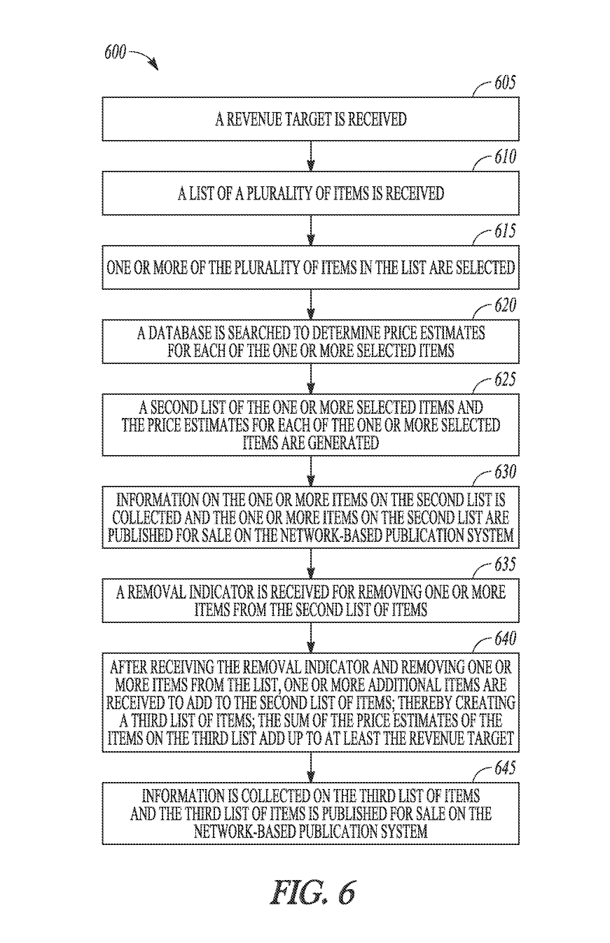

FIG. 6 illustrates an embodiment of a process of identifying a combination of items from a plurality of items for listing on a network-based publication system 100 in order to generate a revenue target. Referring to FIG. 6, at 605, a revenue target is received. As noted in connection with other embodiments, this revenue target is normally received from a user 140 of a network-based publication system 100. At 610, a list of a plurality of items is received. In an embodiment, this list can be created and sent by the user. In another embodiment, this list can be extracted from a database, such as the database 210 of the network-based publication system 100 or a network-based commerce site (e.g., in instances wherein the user already has items published for sale on such a system or site). At 615, one or more of the plurality of items in the list are selected. This selection can be done by the user 140, or it can be done automatically by the processing module 124 of the network-based publication system 100. At 620, the database 210 is searched to determine price estimates for each of the one or more selected items. In an embodiment, the database 210 is part of a network-based publication system 100 such as a network-based commerce site. At 625, a second list of the one or more selected items and the price estimates for each of the one or more selected items are generated. At 630, information on the one or more items on the second list is collected and the one or more items on the second list are published for sale on the network-based publication system 100.

In another embodiment of the process of FIG. 6, at 635, a removal indicator is received for removing one or more items from the second list of items. This feature permits a user 140 to remove items from the list of items that will be published for sale or that have been published for sale. The reasons that a user 140 would like to remove an item or items varies, including reconsidered sentimental reasons attached to the item, and/or strictly business-based reasons such as the item has been on the market too long and/or offered at too low a price. In yet another embodiment, the removal indicator can be automated, such that an item is removed from a list after a certain period of time, if the offered price of the item falls to a certain level, or for some other factor. At 640, after receiving the removal indicator and removing one or more items from the list, one or more additional items are received to add to the second list of items. The reception of and addition of these additional items creates a third list of items. Like with the second list of items, the sum of the price estimates of the items on the third list add up to at least the revenue target. In short, the user 140 can change out one or more items on the proposed combination of items in connection with the user's attempts to try to reach the revenue target. At 645, information is collected on the third list of items and the third list of items is published for sale on the network-based publication system 100.

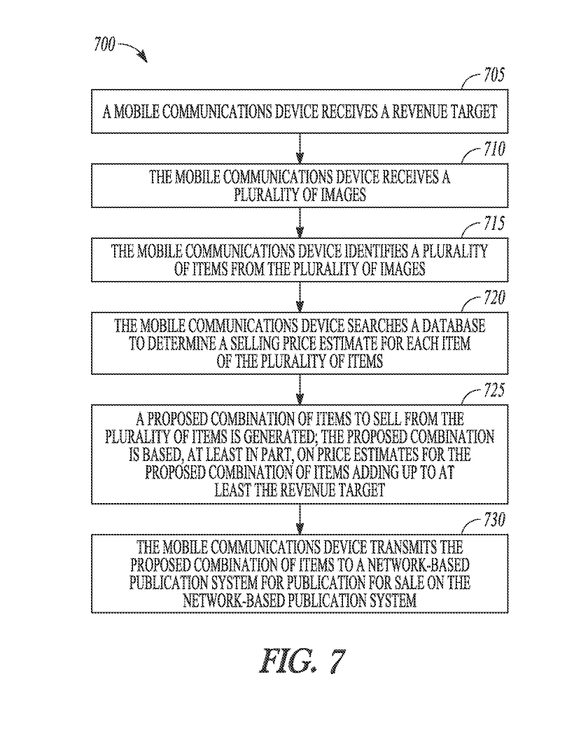

In the embodiment of FIG. 7, a mobile communications device 130 is configured to identify a plurality of items to publish for sale on a network-based publication system 100 to attain a revenue target. Specifically, at 705, the mobile communications device 130 receives a revenue target. The revenue target can be provided by the user 140 of the mobile communications device 130 via the user interface 304 of the mobile communications device 130. At 710, the mobile communications device 130 receives a plurality of images. In one embodiment, the images are received via a camera 310 that is integrated with the mobile communications device 130. In another embodiment, the images can be scanned into the mobile communications device 130. Other means of reception of the images are also possible. In any embodiment, each image of the plurality of images contains an item or items. At 715, the mobile communications device 130 identifies a plurality of items from the plurality of images. At 720, the mobile communications device 130 searches a database to determine a selling price estimate for each item of the plurality of items. At 725, a proposed combination of items to sell from the plurality of items is generated. The proposed combination is based, at least in part, on price estimates for the proposed combination of items adding up to at least the revenue target. At 730, the mobile communications device 130 transmits the proposed combination of items to a network-based publication system 100 for publication for sale on the network-based publication system.

There are several additional features that can be used in combination with one or more of the embodiments of FIGS. 4A, 4B, 5, 6, and/or 7. However, in order to streamline the present disclosure, these additional features will be discussed in combination with the embodiment of FIGS. 4A and 4B.

At 430, the server or processing module 124 in the cloud-based system 100 publishes for sale on the cloud-based system the proposed combination of items. At 431, the server receives a removal indicator for removing one or more items from the proposed combination of items. Then, at 432, the server receives one or more additional items to add to the proposed combination of items. The additional items are used to create a second proposed combination of items. The sum of the price estimates of the items on the second proposed combination of items add up to at least the revenue target. At 433, the server collects information on the second proposed combination of items and publishes for sale on the cloud-based system the second proposed combination of items. As noted above in connection with the embodiment of FIG. 6, these features permit a user to remove and add items to the combination of items for sentimental reasons or business reasons.

At 435, the database 210 of the cloud-based system 100 is a sales history database of a network-based commerce site. The database 210 can provide information on the prices that similar items have sold for in the past. Using such historical data increases the accuracy of the price estimates and the probability that the revenue target will be met. As noted above, at operation 420, the multiple listing engine 120 searches the database 210 to determine a selling price estimate for each item of the plurality of items.

At 440, the server or processing module 124 receives an indication of an item category or an item type associated with the plurality of images. At 441, the server uses the item category or the item type to identify the plurality of items. These features assist in the accuracy of using image recognition in identifying the items in the images. For example, if an item category/type can be associated with an image that indicates that the item in the image is a bicycle, then that information can assist the image recognition software in differentiating between a mountain bike and a touring bike, and further in determining the cost differential of the two.

At 445, the image is received from an application associated with the mobile device 130. Such applications are typically referred to as mobile apps, and such mobile apps can encompass all aspects of the system such as receiving the image of the items, searching the database 210 for price estimates of the items, and generating a combination of the items that sums up to at least the revenue target.

At 450, the server or processing module 124 receives one or more of the plurality of images and the revenue target from the user 140 of the cloud-based system 100. The user 140 in such a case can be the person who is looking to raise revenue that equals or exceeds the revenue target.

At 455, the server or processing module 124 identifies a subset of the proposed combination of items that, when sold together as the subset, generates greater revenue than when one or more items of the subset are not sold with the subset. For example, a set of matching carving knives may bring in more revenue if sold as a set, rather than if sold individually or sold as a partial set with one or more knives missing. In a similar manner, at 456, the server or processing module 124 determines that a single item is to be published for sale as the single item. A reason for selling an item as a single item can be to maximize a price received for the single item. For example, if one item of the combination of items is a luxury item, selling the luxury item in combination with other non-luxury items may drag down the price of the luxury item. Consequently, the user 140 may want to sell the luxury item by itself, and not as part of a set or subset.

In some instances, to bias the sale towards selling the collection as a whole rather than as individual items, the seller may provide a bias price. The bias price is an amount of money the seller is willing to lose by selling the collection as a whole rather than as individual items. The comparison module 129 may, when comparing the sum for the respective items to the bid or offer for the collection as a whole, add the bias price to the bid or offer for the collection as a whole. Thus, even if the sum for the respective items exceeds the bid or offer for the collection as whole, the bid or offer for the collection as a whole may still be winning.

In some instances, the bias price, or a portion of the bias price, may be determined dynamically based on one or more transactions costs imposed on the seller by selling to more than one buyer instead of selling to just one buyer. An example of the transaction costs include, for example, fees charged by the online marketplace to publish the listing or to accept payment from the buyer, or shipping and handling costs. The transaction costs may be determined after the ultimate termination condition has been satisfied.

At 460, the server or processing module 124 examines a sales history of an item type, and at 461, the server identifies an item on the proposed combination of items that is associated with the item type. Thereafter, at 462, a value is assigned to the item on the proposed combination of items that is associated with the item type based on the sales history of the item type. The value relates to an estimated time period needed for the item to sell or a probability of the item selling at a particular price. For example, if it is known that an item can be classified as a riding lawnmower, then the sales history of riding lawnmowers on the network-based publication system 100 can be checked, and an average price, a range of prices, an average time to sale, and a range of time to sale can be determined.

At 465, the server or processing module 124 transmits the proposed combination of items to a second computer processor. At 466, a selection of items from the proposed combination of items is received back from the second computer processor. This selection of items from the proposed combination of items is then published for sale on a network-based publication system. At 467, the selection of items received back from the second computer processor is generated by input from the user 140 of the cloud-based system 100. As noted in connection with other embodiments, these features permit a user to remove and/or add items to the proposed list of items to attempt to sell to attain the revenue target.

At 470, the plurality of items is received from the network-based publication system 100. Specifically, such items may be listed on such sites as eBay®, Pinterest®, and Facebook®, and these images can be used in creating the proposed combination of items.

One or more embodiments can be used for purposes other than generating a proposed list of items in order to attain a revenue target. For example, at 475, the server or processing module 124 generates an insurance claim report relating to a loss of the plurality of items.

As noted above and as further noted at 480, the plurality of items is identified using image recognition software, and as noted above and as further noted at 485, one or more of the plurality of images comprises a plurality of items.

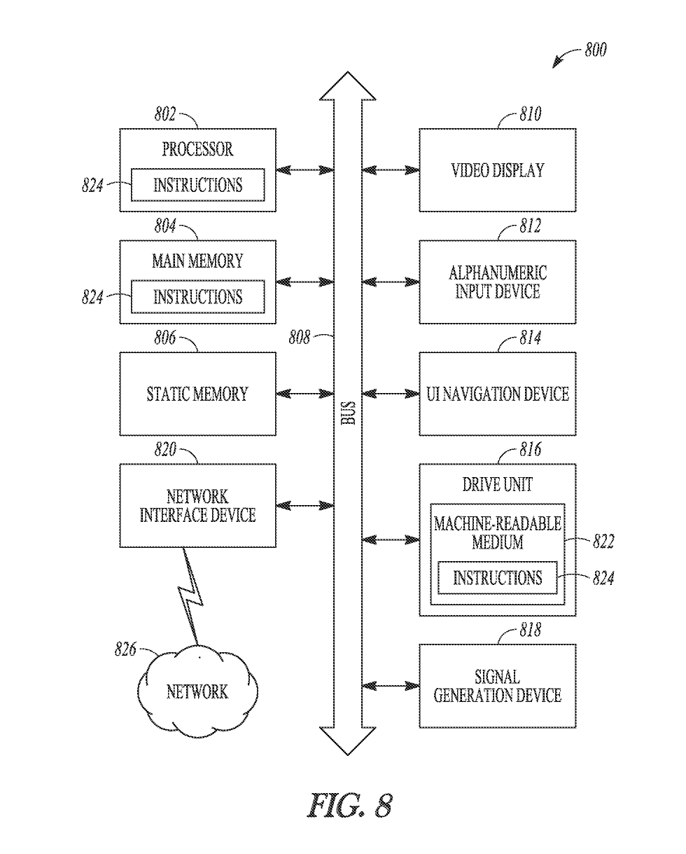

Proceeding to FIG. 8, the example computer system 800 includes a processor or multiple processors 802 (e.g., a central processing unit (CPU), a graphics processing unit (GPU), or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 may also include an alphanumeric input device 812 (e.g., a keyboard), a cursor control device 814 (e.g., a mouse), a disk drive unit 816, a signal generation device 818 (e.g., a speaker) and a network interface device 820.

The disk drive unit 816 includes a computer-readable medium 822, on which is stored one or more sets of instructions and data structures (e.g., instructions 824) embodying or utilized by any one or more of the methodologies or functions described herein. The instructions 824 may also reside, completely or at least partially, within the main memory 804 and/or within the processors 802 during execution thereof by the computer system 800. The main memory 804 and the processors 802 may also constitute machine-readable media.

The instructions 824 may further be transmitted or received over a network 826 via the network interface device 820 utilizing any one of a number of well-known transfer protocols (e.g., Hyper Text Transfer Protocol (HTTP)).

While the computer-readable medium 822 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, systems and methods for achieving targeted revenue in marketplace listings using a camera enabled mobile device have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

1. A cloud-based system comprising:
a server communicatively coupled to a network and including a processor and a memory device, the memory device including instructions that when executed on the server, cause the server to:
receive a revenue target;
receive a plurality of images, each image of the plurality of images containing an item;
identify a plurality of items from the plurality of images;
search a database to determine a selling price estimate for each item of the plurality of items; and
generate a proposed combination of items to sell from the plurality of items based, at least in part, on price estimates for the proposed combination of items adding up to at least the revenue target.

2. The cloud-based system of claim 1, wherein the memory device includes instructions for causing the server to publish for sale on the cloud-based system the proposed combination of items.

3. The cloud-based system of claim 2, wherein the memory device includes instructions for causing the server to:
receive a removal indicator for removing one or more items from the proposed combination of items; and
receive one or more additional items to add to the proposed combination of items, thereby creating a second proposed combination of items, such that the sum of the price estimates of the items on the second proposed combination of items add up to at least the revenue target.

4. The cloud-based system of claim 3, wherein the memory device includes instructions for causing the server to collect information on the second proposed combination of items and publish for sale on the cloud-based system the second proposed combination of items.

5. The cloud-based system of claim 1, wherein the database comprises a sales history database of a network-based commerce site.

6. The cloud-based system of claim 1, wherein the memory device includes instructions for causing the server to:
receive an indication of an item category or an item type associated with the plurality of images; and
use the item category or the item type to identify the plurality of items.

7. The cloud-based system of claim 1, wherein the image is received from an application associated with a mobile device.

8. The cloud-based system of claim 1, wherein the computer processor is operable to receive one or more of the plurality of images and the revenue target from a user of the cloud-based system.

9. The cloud-based system of claim 1, wherein the memory device includes instructions for causing the server to identify a subset of the proposed combination of items that when sold together as the subset generate greater revenue than when one or more of the subset are not sold with the subset.

10. The cloud-based system of claim 1, wherein the memory device includes instructions for causing the server to determine that a single item is to be published for sale as the single item, thereby maximizing a price received for the single item.

11. The cloud-based system of claim 1, wherein the memory device includes instructions for causing the server to:
examine a sales history of an item type;
identify an item on the proposed combination of items that is associated with the item type; and
assign a value to the item on the proposed combination of items that is associated with the item type based on the sales history of the item type, the value relating to an estimated time period needed for the item to sell or a probability of the item selling at a particular price.

12. The cloud-based system of claim 1, wherein the memory device includes instructions for causing the server to:
transmit the proposed combination of items to a second computer processor, and
receive back from the second computer processor a selection of items from the proposed combination of items to publish for sale on a network-based commerce system.

13. The cloud-based system of claim 12, wherein the selection of items received back from the second computer processor is generated by input from a user of the cloud-based system.

14. The cloud-based system of claim 1, wherein the plurality of images items is received from a network-based publication system.

15. The cloud-based system of claim 1, wherein the memory device includes instructions for causing the server to generate an insurance claim report relating to a loss of the plurality of items.

16. The cloud-based system of claim 1, wherein the plurality of items is identified using image recognition software.

17. The cloud-based system of claim 1, wherein one or more of the plurality of images comprises a plurality of items.

18. A process comprising:
receiving a revenue target;
receiving a list comprising a plurality of items;
selecting one or more of the plurality of items in the list;
searching a database to determine price estimates for each of the one or more selected items;
generating a second list of the one or more selected items and the price estimates for each of the one or more selected items; and
collecting information on the one or more items on the second list and publishing for sale on a network-based publication system the one or more items on the second list.

19. The process of claim 18, comprising identifying a subset of the second list of items that when sold together as the subset generate greater revenue than when one or more of the subset are not sold with the subset.

20. A mobile communications device configured to:
receive a revenue target;
receive a plurality of images, each image of the plurality of images containing an item;
identify a plurality of items from the plurality of images;
search a database to determine a selling price estimate for each item of the plurality of items;
generate a proposed combination of items to sell from the plurality of items based, at least in part, on price estimates for the proposed combination of items adding up to at least the revenue target; and
transmit the proposed combination of items to a network-based publication system for publication for sale on the network-based publication system.
